(19) United States
(12) Patent Application Publication
(10) Pub. No.: US 2021/0260421 A1
(43) Pub. Date: Aug. 26, 2021

(54) FIRE CONTROL AND PREVENTION

(71) Applicant: Gideon Raya, Gan Ner (IL)

(72) Inventor: Gideon Raya, Gan Ner (IL)

(21) Appl. No.: 17/170,051

(22) Filed: Feb. 8, 2021

Related U.S. Application Data
(60) Provisional application No. 62/978,856, filed on Feb. 20, 2020.

(51) Int. Cl. A62C 3/02; A62C 37/36

(52) U.S. Cl. CPC A62C 3/0271; A62C 37/36

(57) ABSTRACT

A system is provided for minimization of fire damages which includes one or more first sensor for detecting animal activity; and one or more computerized module that performs analysis on the input received from the first sensor, to assess the likelihood and identify fire events. The first type sensor can be a kind of imaging device such as a visible light camera, infrared camera or radar. The analysis may include identification of animal response to signs of fire. Those signs of fire can include sound, sight, and smell. Animal response to the signs of fire can include panic. In many cases the identification of animal response to fire includes a detection of animals escaping away from the fire. The first sensor may be installed on an aircraft such as airplane, helicopter, drone, and balloon.

Also provided, a method which includes analyzing of animal activity for assessing likelihood and identifying fire event.

### TECHNICAL FIELD

The present invention relates to fire control and prevention. More particularly, the invention relates to identifying likelihood of life and property threatening fires; prevention; extinguishing; and supporting the management of firefighters forces.

### BACKGROUND

Wildfires are unplanned fires that burn in forests and other wildlands, such as shrub or grass communities. Factors involved in the increase in the number and size of wildfires are:
1. Increased complexity of implementing fire suppression, especially with the increased residential development in the wildland urban interface (WUI).
2. Increased complexity of implementing fuels treatment programs has resulted in hazardous accumulations of forest and rangeland debris, and fuels such as fallen leaves, branches, excessive plant overgrowth, ladder fuels, and dead vegetation. “Ladder fuels” are positioned so that fire can spread from low to medium to high vegetation (for example from grass to bushes to trees). On a single tree, the fire can spread from ground level branches to mid branches and eventually to the crowns (tops) of the trees.
3. Climate change is producing drier and hotter weather patterns and longer “fire seasons.”
4. Overcrowded stands and drought patterns result in cyclical insect and disease outbreaks, which create large areas of dead and dying wood.

In the United States alone, 4.5 million homes were identified at high or extreme risk of wildfire. An average of 5 million acres burns every year in the United States, causing millions of dollars in damage-. Once a fire begins, it can spread at a rate of up to 14.5 miles per hour (25 kph), consuming everything in its path. In addition to the direct threat from burning, wildfires also release pollutants detrimental for human health and ecosystems. Close to the fires, smoke is a health risk because it contains a mixture of hazardous gases and small particles that can irritate the eyes and respiratory system. Apart from dry vegetation and high temperatures, spreading of fires depends on winds direction and speed. In particular in mountainous terrain, where localized wind systems may cause the fire to jump over to neighboured mountains. The localized winds are further altered by the fire itself, since a region under fire is heating up, compared to the surroundings. Wind conditions near a fire affect a rather small region and might thus not be recognized by the weather stations. This makes predicting the further behaviour and spreading of the fire very challenging. The severity of the results caused by fires has led to many efforts in an attempt to reduce the frequency and intensity of fires and to improve fire extinguishing measures. Patent application WO2011103915 describes apparatus and methods for pro-active, intelligent fire suppression and/or control using a micro-controller connected to detection sensors and fire suppression devices. The apparatus is intended to detect the location and direction of the fire and to allow directing a fire suppressant at the source of the flame. Patent U.S. Pat. No. 7,275,604 describes multi-zone firewall detection system utilizing computer vision technique based method and system for detecting and extinguishing fire. Patent U.S. Pat. No. 5,165,482 discloses a fire deterrent system, operating in a preemptive manner by detecting the impending approach of a wildfire within the vicinity of the structure to be protected. The system includes an anemometer to measure the wind magnitude and direction at the home site as well as a plurality of sensors sited at various locations around the defensive perimeter to detect the ignition of fires within this defensive perimeter. Such a system is described as to include means for monitoring fire retardant fluid content in a holding tank. Patent application US20150129245 describes fire retardant dispersion devices for dispersing various types of fire retardant products. U.S. Pat. No. 9,251,698 relates to forestry management, describes using soil sensor units. U.S. Pat. No. 5,936,245 discusses a method and system for detecting, by means of specific processings of images of an area flown over taken in several spectral bands, signs indicative of a stress of the vegetation and the presence of spots where fire is likely to occur or spread.

Still, the inventor of the present invention believes that there are additional measures, not described in the above publications, that can greatly contribute to successful coping with fires.

The terms “materials”, and “fire extinguishing agents and/or fire retardants” may be used interchangeably hereinafter.

The terms “fire post”, “fire fighting post”, “fire station” and “fire fighting station” may be used interchangeably hereinafter.

The terms “first sensor”, and “first type sensor” may be used interchangeably hereinafter. Similarly, mutatis mutandis, for “second sensor”, “third sensor”, “fourth sensor”, “fifth sensor” and “sixth sensor”.

The term “sensor” may refer herein to sensors of types that are being discussed below or other sensors known in the art or to be developed in future.

The terms “fire damage minimization system”, and “system” may be used interchangeably hereinafter.

The terms “system user”, and “system operator” may be used interchangeably hereinafter.

The terms “monitored area”, and “controlled area” may be used interchangeably hereinafter.

### SUMMARY OF EMBODIMENTS OF THE INVENTION

Most animal species respond to fire. These responses vary widely among species. Many vertebrate species flee or seek refuge, but some vertebrates and many insects are attracted to burning areas. Birds may fly away while mammals will run. Amphibians and other small creatures will burrow into the ground, hide out in logs, or take cover under rocks. Other animals, including large ones like elks will take refuge in streams and lakes.

According to some aspects of the invention there is provided a system for minimization of fire damages which includes one or more first sensor for detecting animal activity; and one or more computerized module that performs analysis on the input received from the first sensor, to assess the likelihood and identify fire events. The first type sensor can be a kind of imaging device such as a visible light camera, infrared camera, radar, and combinations thereof. The analysis may include identification of animal response to signs of fire. Those signs of fire can include sound, sight, and smell. Animal response to the signs of fire can include panic. In many cases the identification of animal response to fire includes a detection of animals escaping away from the fire. The first sensor may be installed on an aircraft such as airplane, helicopter, drone, and balloon.

Some systems embodying the invention include one or more second sensor, e.g., camera, capable of detecting one or more parameter indicative for vegetation condition, wherein the assessment of likelihood of fire event includes analysis on input received from that second sensor pertaining vegetation condition. Vegetation condition can be related to degree of vegetation dryness which can be determined according to measurements of pH in plant organs, electrical capacitance of plants organs, camera imaging of dried plant parts, and size of pests populations characteristic of a dryness in vegetation. Vegetation indicators detected by the second sensor may include plant communication.

Some systems embodying the invention include one or more third sensor measuring one or more parameter related to the soil. The assessment of the likelihood of fire event includes analysis on input received from the third sensor. The third sensor can be one that measures soil humidity, or it can be a camera. Camera images of the soil may be analyzed by human or preferably by the computerized module. Such images may indicate the dryness of the soil. In some cases analysis of soil microorganism populations is performed. For example the size of such populations. The type of microorganisms that is particularly relevant to such analysis is that of microorganisms that are sensitive to dryness.

One or more fourth type of sensor may be included which measures weather parameters, in some cases installed on aircraft. The assessment of the likelihood of fire event includes analysis on input received from the third sensor. Weather parameters can include wind direction, wind speed, temperature, and relative humidity. Wind speed and its direction, can be used for determining the time it can take to the fire to reach from one place to another.

One or more fifth type sensor can be included for measurements related to fire magnitude. One or more sixth sensor for detecting of fire smell may be included as well. Fire magnitude may be determined according to measurements of temperature; according to camera imaging; radiation; and sound. Smell detection can be used not only for assessing fire magnitude and but also for determining which fuels feeds the fire, e.g., kinds of vegetation which determine the type and quantity of fire extinguisher to be used. The assessment of the likelihood of fire event includes analysis on input received regarding fire magnitude and smell.

The system according to some embodiments of the invention may send alarms regarding the likelihood of fire based on analysis performed by the system's computerized module. In some examples the system's computerized module receives input regarding the location of firefighting personnel for assisting in controlling and managing fire extinguishing efforts. The computerized module may send instructions or recommendations to firefighting personnel based on analysis on the input pertaining the location of firefighting personnel. The computerized module may receive input regarding arson-related criminal activity, e.g., images and/or sound recording and communicate it to law enforcement authorities.

Some systems embodying the invention include one or more containers for storing one or more material e.g., extinguishing agent and/or fire retardant. In case of a fire event, the computerized module generates command signals to the containers for emitting the extinguishing agent and/or fire retardant. Selection of optimal extinguishing agent and/or fire retardant to be used in a fire event is done, based on analysis being performed by the computerized module regarding which extinguishing agent and/or fire retardant are most suitable for minimizing damage under prevailing conditions. Also the quantities of the fire extinguishing agents and fire retardants for use during different stages of the fire event are determined based on the above analysis regarding prevailing conditions. Types and quantities of materials, i.e., fire extinguishing agents and/or fire retardants, may be determined, according to fire magnitude, weather conditions including wind direction, vegetation, risk to animals and humans, proximity to hazardous substances, and the proximity to agricultural areas. Some systems embodying the invention include GPS for determination of system location fed as input from the GPS to the computerized module; and Wifi for communication between the computerized module, the sensors, containers, and communication devices.

A method according to some aspect of the invention includes analyzing animal activity for assessing likelihood and identifying fire event. In some occasions animal activity is detected by one or more first type sensor located in a monitored area. The method includes identifying that the animal activity is a response to signs of fire. Signs of fire may include sound, sight, smell and combinations thereof. Animal response to fire can be characterized and learned, for example by using artificial intelligence. In some instances the response of the animals to fire is escape. Detection and identification of animal escape from fire can be according typical patterns of animal behavior in such case, for example, movement patterns of an animal group such as direction, speed, uniformity in the direction of movement of members of the animal group, and combinations thereof. Sometimes animals can get into panic due to fire. Such panic may be identified for assessing likelihood of fire event. In some cases the method includes inhabit of animals in a monitored area, whose response to a fire is easily identifiable and predictable.

Methods according to some embodiments of the invention include assessing the likelihood of fire event that include analyzing input pertaining vegetation condition, soil parameters, smell. and microorganisms as mentioned above.

### BRIEF DESCRIPTION OF DRAWINGS

Preferred embodiments, features, aspects and advantages of the present invention are described herein in conjunction with the following drawings:

FIGS. 1A-F. schematically depict the movements of several members of a herd or a group of animals. FIG. 1A depicts members at resting area; FIG. 1B depicts members in leisurely movement; FIG. 1C depicts members escape from a single predator; FIG. 1D depicts members gather as response to a perimeter attack by a pack of predators; FIG. 1E depicts members flee away from a flood to river banks; and FIG. 1F depicts members escape from wildfire front.

FIG. 2. schematically depicts area which includes a residential neighborhood adjacent to a grove, monitored and controlled by a system according to some embodiments of the invention. Between the residential neighborhood and the grove, as well as inside the grove, there are fire fighting posts which include sensors (not shown) and containers (not shown) for materials storage e.g, fire retardants.

### DETAILED DESCRIPTION OF EMBODIMENTS

In this disclosure, aspects of the present invention are explained by way of example. However, it should be understood that the below examples are in no way limiting embodiments of the present invention.

Most animal species respond to fire. These responses vary among species. Many vertebrate species flee or seek refuge, but some vertebrates and many insects are attracted to burning areas. Birds may fly away while mammals will run. Amphibians and other small creatures will burrow into the ground, hide out in logs, or take cover under rocks. Other animals, including large ones like elk, will take refuge in streams and lakes. A few bird species are attracted to active burns. Raptor and scavenger species are attracted to fire or use recent burns for hunting e.g., northern harrier, American kestrel, red-tailed hawk, red-shouldered hawk, Cooper's hawk, turkey and black vultures. Some predators see the fleeing species as an opportunity for hunting. Bears, raccoons, and raptors, for instance, have been seen hunting animals trying to escape the flames. Other behavioral responses to fire include rescuing youngs from burrows, approaching flames and smoke to forage, and entering recent burns to feed on charcoal and ash. In Australia, experiments have shown smoke awakens Gould's long-eared bats and fat-tailed dunnarts, enabling their escape from fire. Heterothermic mammals are able to respond to fire stimuli, such as smoke, to arouse from torpor as an initial response to fire. Animals also recognise the distinct sounds of fire. Reed frogs flee towards cover and eastern-red bats wake from torpor when played the crackling sounds of fire. It is common to see large animals fleeing a fire, such as the kangaroos filmed hopping from a fire front. Kangaroos and wallabies make haste to dams and creek lines, sometimes even returning through a fire to find safety in areas already burned.

According to some aspects of the invention there is provided a system for minimization of fire damages which includes one or more first sensor e.g., camera, for detecting animal activity; and one or more computerized module that performs analysis on input received from the first sensor to assess the likelihood and identify fire events. The analysis may include identification that the animal activity is a response to signs of fire. The signs of fire can include sound, sight, and smell. The animal response to the signs of fire can include panic. In some cases the identification of animal response to fire is a detection of animals escaping away from the fire. A system according to embodiments of the invention can be used for both alerting and performing preventive and firefighting operations.

A method according to some aspect of the invention include analysing input regarding animal activity for assessing likelihood and identifying fire event. In some occasions the input is received from one or more first type sensor located in a monitored area.

Animal response to fire can be characterized and learned, for example by using artificial intelligence. In some cases the response of the animals to fire is escape. Detection and identification of animal escape from fire can be according typical patterns of animal behavior in such case, for example, movement patterns of an animal group such as direction, speed, uniformity in the direction of movement of members of the animal group, and combinations thereof. In some examples of the invention other kinds of animal response are used for analysis of likelihood of fire event, e.g., those mentioned above. A method according to embodiments of the present invention can be used for both alerting and performing preventive and firefighting operations.

The way fire is identified can vary depending on conditions such as day and night, vegetation, animals, animal response, climate, soil, type and intensity of fire, and smoke. Means for fire detection may include scent detectors, temperature gauges, infrared cameras, image/video detection, and image processing.

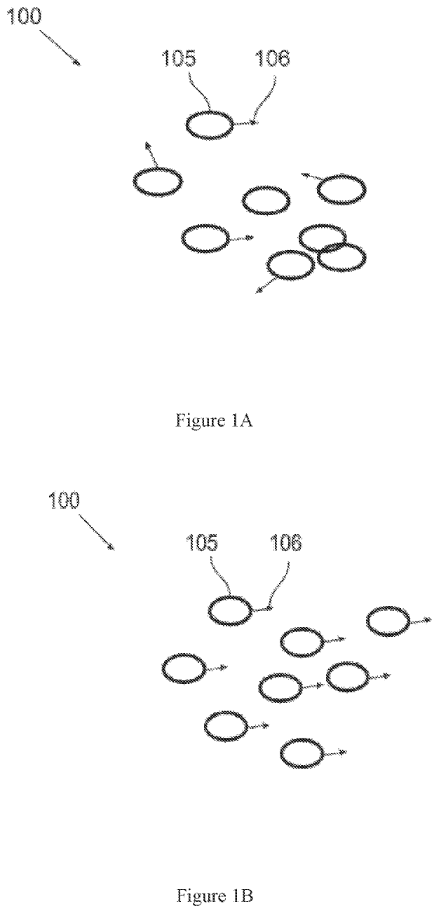

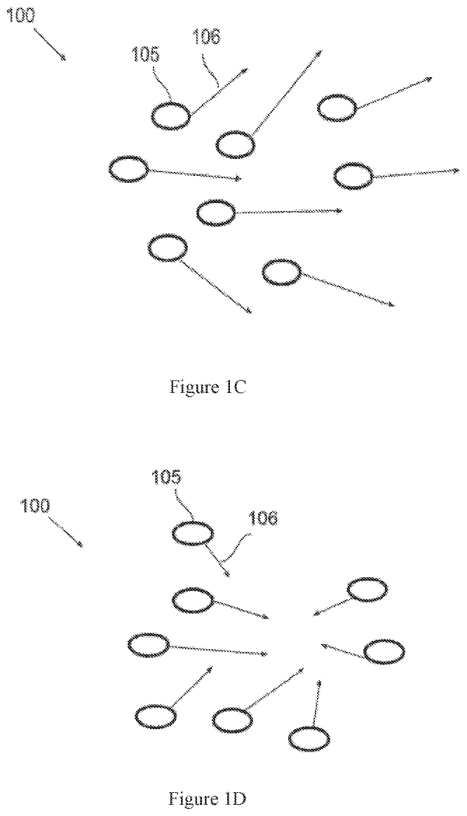

FIG. 1. schematically depicts the movements of several members 105 of a herd or group of animals. Arrows 106 denote, vectors of the movements of members 105. Arrows 106 length varies between FIGS. 1A to 1F to represent different speeds in each case. Longer arrow represent faster speed (running). FIG. 1A illustrates herd or group of animals 100 at a resting area where some herd members are not moving, and some are moving slowly in different directions. FIG. 1B illustrates herd or group of animals 200 in leisurely movement of which its members 105 are moving slowly at the same direction. FIG. 1C depicts herd or group of animals escape from a single predator where members of herd 300 are escaping on a fast run in different directions in the form of a fan extending away from the chasing predator. FIG. 1D illustrates members 105 of herd or group of animals 400 gather as response to a perimeter attack by a pack of predators. The movements of members 105 are represented by arrows 106 pointing inward away from the circumference. FIG. 1E illustrates herd or group of animals run away from a flooding in two opposite direction towards creek banks. FIG. 1F illustrates herd or group of animals 600 escape from wildfire front. Members 105 of herd 600 are running in the same direction. It can be seen that the behavior of the animals varies according to the case and can be used as an indication to identify the cause of the animal reaction, such as in the case of a fire. As the reader may understand, in the cases depicted in FIGS. 1A-F, it is advantageous if the the first type sensor is installed at a high position such as on aircraft, e.g., drones, or balloons. Sometimes animals can get into panic due to fire. Such panic may be analyzed for identification of fire events. In some cases the method includes inhabit of animals in a monitored area, whose response to a fire is easily identifiable and predictable.

Methods according to some embodiments of the invention include assessing the likelihood of fire event that include processing of input pertaining vegetation condition, soil parameters, smell and microorganisms as mentioned above. Upon exposure to biotic or abiotic stressors (environmental conditions), plants can activate hydraulic, chemical, or electrical long-distance signals to initiate systemic stress responses. In recent years, several metabolites putatively involved in long-distance signaling have been identified. There has been some evidences for involvement of chemical compounds (e.g., jasmonic and abscisic acids) in the rapid inhibition of photosynthetic rate and stomata conductance in distant undamaged tobacco leaves after local burning. The inventor of the present invention has envisioned the possibility of using long-range communication between plants, detected by sensors communicating with the computerized module of a system in accordance with some embodiments of the present invention to warn of fire danger.

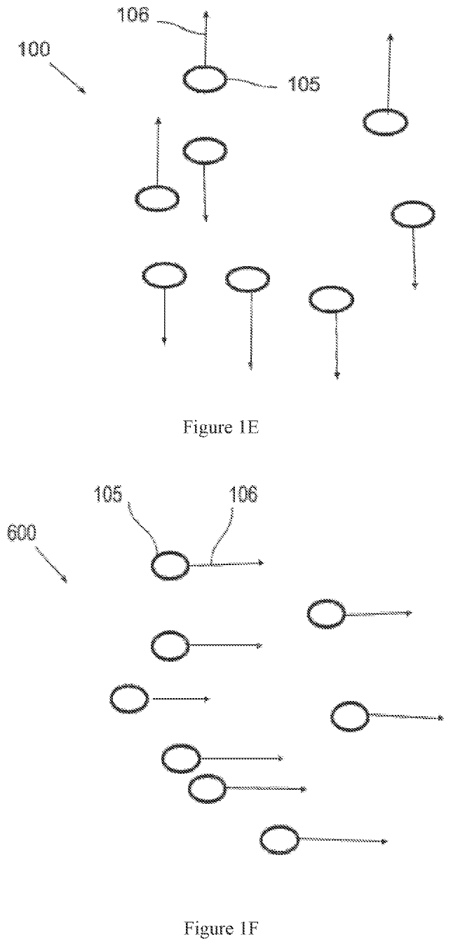

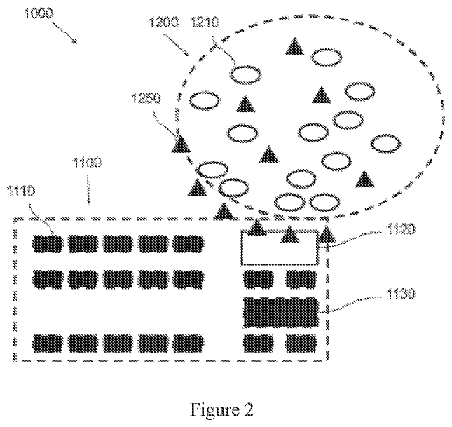

FIG. 2. schematically depicts area 1000 which includes residential neighborhood 1100 adjacent to grove 1200 where trees and bushes 1210 grow. In residential neighborhood 1100 there are houses 1110, school 1120, and playground 1130. Some houses 1110, and playground 1130 located at the edge of neighborhood 1100 bordering grove 1200. Area 1000 is monitored and controlled by a system according to some embodiments of the invention utilizing sensors (not shown), located inside grove 1200 and between grove 1200 and neighborhood 1100. One or more sensor is installed in fire fighting posts 1250 which may include containers (not shown), for materials storage, e.g, fire retardants. In case of a fire event, materials can be emitted from the containers to extinguish the fire. Fire fighting posts 1250 are in communication with one or more computerized controller (not shown). Releasing of materials for fire fighting posts 1250 may be done as result of command signal generated by one or more computerized module which controls fire fighting stations 1250, or as result of a command signal coming from a computerized module installed in a firefighting station 1250, which analyze input received from one or more sensor installed in fire fighting station 1250, and/or from one or more sensor not installed in fire fighting station 1250.

A system according to some embodiments of the invention may be operated autonomously without human intervention, although such option for human intervention may be included. A possible combination of human control with autonomous action may be the case where the system waits for a certain period of time for human operator intervention, and if such intervention does not occur, the system enters autonomous action. In some examples illustrated in FIG. 2, the first kind sensor can detect animals escaping out of the grove towards the adjacent neighborhood or toward a nearby creek (no shown). Preferably the analysis is done on input from several sources in order to improve the reliability of the analysis by combining information from diverse sources, e.g., from different sensors types discussed herein. The area monitored and controlled by the system can be pre defined as zone 1000 shown in FIG. 2. However, in some cases, the control area definition can be changed according to human decision or decision made by artificial intelligence. Examples for monitored areas different from the one shown in FIG. 2, may be a field, a nature reserve, an industrial zone, and a military training area and combinations thereof. In some examples, fire fighting posts include remotely operated cameras. It is preferable that the likelihood of fire event and its detection be based on input obtained from a number of sensors scattered in the controlled area in order to create a reliable indication. For example, in the case of animal escape, detection by a large number of sensors located around the monitored area will be considered as a more likely indication of a fire event than detection by a single sensor or a small number of sensors. In some examples, it can be determined that only when a certain percentage, predetermined by the system user, of the sensors, detect indication of fire event, the system will be activated, e.g, send commands for spraying extinguishing materials. In some examples, first type sensors are installed at the perimeter of a monitored area, at 50 meters distance between them. In such example it can be determined that the required percentage of detections, required to determine high probability of fire event may be a predetermined percentage of detections received from sensors installed only in one side of the monitored area in case that there are no indications received from sensors installed in other sides around the monitored area. Such an arrangement may be suitable in case that there is a detection of animals escaping in one direction out of one side of the monitored area. It can be determined that the system will be activated according to a predetermined threshold probability of a fire event calculated by one or more computerized module, that is, above certain value, the system will be activated to release extinguishing materials. In determination of criteria for system operation, machine learning, and artificial intelligence may be implemented, with or without human intervention. Monitored areas can be in various sizes, e.g., one square mile, thousands of square kilometers, and tens of thousands of square kilometers. For different sizes of areas, different numbers of fire posts and sensors may be suitable for efficient fire control. Sensors can be installed in the fire posts or separately. They can be stationary, or being installed on vehicles such as aircrafts. The computerized module may deal with a big amount of input being received from sensors and other sources that amounts to “big data”. By the size of the monitored area, the number of sensors can reach tens, hundreds, thousands, and so on. A possible combination of control using stationary sensors and airborne sensors could be by sending a swarm of drones equipped with sensors by the computer module as response to initial input obtained from stationary sensors. The swarm reaches the suspicious area and increases the amount of input the computerized module receives pertaining the suspicious area, as well as obtaining a vertical angle of view from above, all to build as much credibility as possible regarding an assessment of a fire event probability or detection. According to some systems and methods embodying the invention, fire alerts and activation of extinguishing means installed in the fire fighting posts are done according to commands being sent from the computerized module which performs analysis on input received from the sensors discussed herein, and possibly, from other sources, e.g., databases, and humans. As mentioned above, fire fighting posts may include storage containers for materials such as flame retardants and extinguishers. There are cases where such fire fighting posts also include containers for other materials such as fertilizers, herbicides, pesticides, and water for irrigation. One or more nozzles may be fluidly connected to one or more container for emitting materials according to command being received from the computerized module e.g., emitting fire extinguishing material in case of a fire event. The materials are forced through the nozzles by any driving force selected according to design considerations, e.g., gas pressure or electromechanical means. The materials stored in the containers can be in various states such as, liquids, powders or solids. Solid materials can be in various forms such as capsules and tablets. In some cases each container is connected to its own nozzled.

System location can be determined based on GPS. The system's computerized module will in many cases be linked to a memory module or cloud that includes required data such as regional maps and local maps of more specific areas. The location of the system can used for connection to a fire control system of the responsible authority of the country or region. Network connectivity can be used to transfer or receive data to and from users or databases, e.g., for update of system's software version. Communication between systems installed at different locations can be important in dealing with large-scale fire events, with information from one system being received by a system installed at another location, processed by the computerized module for transmitting alerts and initiating fire prevention and extinguishing operations. Alerts can be broadcast to the authorities and/or directly to citizens who are at risk according to residential address information. Communication between system components can include alerts regarding a low content in containers, malfunctions, low battery charging, and power outages. All this data is transmitted to the computerized module for analysis and initiation of operations or alerts to the system operators. For example, in the case of low content of extinguishing material in one of the fire fighting posts, ordering material, and in case of fire event, activating a nearby fire fighting post. According to some examples, the system includes air monitoring means to alert air pollution. In order to prevent criminal or terrorist activity, systems embodying the invention may be equipped with cyber protection. In some examples, the system is linked to law enforcement agencies to help identify, for example, through a camera, criminal activity. The information can be transmitted from the system or to the system to identify possible fire event. Some types of systems are decentralized, whereby each fire fighting post includes a computerized module that communicates with computerized modules of other fire fighting posts. Such a system can function as an artificial neural network.

For human intervention, a privilege hierarchy can be implemented in dealing with different cases, for example according to the complication and scale. In some cases, specific training programs tailored to the particular area for use by firefighters are stored in the system's memory module, including area information, fire extinguishing guidelines, and recommended equipment for use in that area. Such information can be fed to simulators used to train firefighting teams. The information can include past events according to which training programs can be updated.

Preferably the system includes an artificial intelligence-based learning system for updating autonomous operation. Comparison of data regarding weather in the past and present or forecasted weather may assist in assessing likelihood of fire events. Weather data can include information received from external source, e.g., internet, or from local measurements made by local sensors communicated directly with the system's computerized module.

System communication with firefighting forces may include fire alerts, information regarding areas where the system does cover, recommendations for fire fighting actions, location of forces, animal response, recommendations for blocking roads and evacuation of people. In some examples the system's computerized module communicates with firefighting airplanes or drones, guiding them to locations where extinguishing materials and/or fire retardants should be dropped. In some cases, drones are stationed in system's fire fighting posts. In some examples drones or airplanes include sensors of the types described above. A system embodying the invention would provide recommendations not only to extinguish occuring fire, but also regarding preventive measures to be taken. Preventive measures may be done by the system autonomously. For example, spraying water or other fire retardants during hot dry days and thinning vegetation. In some cases, the system provides information on fire-prone areas, for example, based on historical data and weather conditions. Typically, the system performs non-stop monitoring and collects information about unusual events that can be indicative of a fire event possibility. Some possible hardware features of the system embodying the invention include resistance to weather fire and extreme heat; and independent source of electrical power supply for a long period of time, e.g., two years.

1. A fire damage minimization system comprising:
at least one first sensor detecting animal activity; and
at least one computerized module that performs analysis on input received from said first sensor,
wherein said analysis is for assessment of likelihood and identification of a fire event.

2. The system of claim 1, wherein said analysis comprises identification of animal response to signs of fire, based on said analysis on input being received from said first sensor.

3. The system of claim 1, comprising at least one second sensor capable of detecting at least one parameter indicative for vegetation condition, wherein said computerized module performs analysis on input received from said second sensor for said assessment of likelihood and identification of fire event.

4. The system of claim 3, wherein said second sensor detects plant communication relating to fire.

5. The system of claim 1, further comprising at least one third sensor measuring at least one parameter related to the soil, wherein said computerized module performs analysis on input received from said third sensor for said assessment of likelihood and identification of fire event.

6. The system of claim 5, wherein said measuring comprising soil humidity.

7. The system of claim 5, wherein said at least one soil parameter relates to soil microorganisms.

8. The system of claim 1 comprising at least one fourth sensor for weather related measurements, wherein said computerized module performs analysis on input received from said fourth sensor for said assessment of likelihood and identification of fire event.

9. The system of claim 1, comprising at least one fifth sensor for measurements related to fire magnitude, wherein said computerized module performs analysis on input received from said fifth sensor for said assessment of likelihood and identification of fire event.

10. The system of claim 1, comprising at least one sixth sensor for detecting fire smell, wherein said computerized module performs analysis on input received from said sixth sensor for said assessment of likelihood and identification of fire event.

11. The system of claim 1, comprising means to identify the location of firefighting personnel to assist in controlling and managing fire extinguishing efforts,
wherein said module receives input from said means identifying location of firefighting personnel, and
wherein said module sends instructions or recommendations to firefighting personnel based on analysis of said input from said input from said means identifying location of firefighting personnel.

12. The system of claim 1, comprising at least one container for storing fire at least one extinguishing agent and/or at least one fire retardant, wherein in case of a fire event, said module generates command signals to said containers for emitting said extinguishing agent and/or fire retardant wherein said module select at least one optimal extinguishing agent and/or at least one optimal fire retardant according to analysis performed by said module regarding which of extinguishing agent or fire retardant is most suitable for minimizing fire damage under the prevailing conditions of the fire event.

13. A method for minimizing fire damage comprising analyzing animal activity for assessing likelihood and identifying a fire event.

14. The method of claim 13, comprising detecting said animal activity by at least one first sensor located in a monitored area.

15. The method of claim 14 comprising determining that said activity is typical to response of said animal to fire according to the movement patterns of a group of said animal selected from the group consisting of direction, speed, uniformity in the direction of movement of members of the animal group, and combinations thereof.

16. The method of claim 15, comprising inhabit animals in said monitored area, whose response to a fire is easily identifiable and predictable.

17. The method of claim 15, comprising learning and characterizing said animal response to signs of fire.

18. The method of claim 17, wherein said learning and characterizing being done by artificial intelligence.

19. The method of claim 13, wherein said assessing likelihood of fire event comprises analyzing input pertaining to a likelihood of fire event selected from the group consisting of vegetation condition and soil condition.

20. The method of claim 19, wherein said input indicative of plant communication.
